(19) United States
(12) Patent Application Publication
(10) Pub. No.: US 2003/0068087 A1
(43) Pub. Date: Apr. 10, 2003

(54) System and method for generating a character thumbnail sequence

(76) Inventors: Watson Wu, Hsinchu (TW); Ray Huang, Hsinchu (TW)

Correspondence Address: BIRCH STEWART KOLASCH & BIRCH, PO BOX 747, FALLS CHURCH, VA, 22040-0747, US

(21) Appl. No.: 10/033,782

(22) Filed: Jan. 3, 2002

(30) Foreign Application Priority Data
Oct. 5, 2001 (TW) 90124776

(51) Int. Cl. G06K 9/46

(52) U.S. Cl. 382/190

(57) ABSTRACT

A system for generating a character thumbnail sequence includes a video-receiving module, a decoding module, a video-extracting module and a character-thumbnail-sequence-generating module. The video-receiving module receives video source data. The decoding module decodes video source data into video data. The video-extracting module extracts at least one key frame from the video data according to a character-image extraction guide. The character-thumbnail-sequence-generating module generates a thumbnail sequence according to the extracted key frame. The invention also discloses a method for implementing the above-mentioned method for generating the character thumbnail sequence.

### BACKGROUND OF THE INVENTION

1. Field of the Invention

The invention relates to a system and method for generating a character thumbnail sequence, in particular to a system and method for automatically generating a character thumbnail sequence wherein computer software is used to analyze video content.

2. Description of the Related Art

Generally speaking, the video includes a plurality of individual frames that are sequentially output. For example, using the NTSC standard, 29.97 interlaced frames are broadcast per second; and using the PAL standard, 25 interlaced frames are broadcast per second. When a user views the frames, a significant problem is that the number of frames is too great. Taking the NTSC standard as an example, a one-minute video includes almost 1,800 frames. Thus, the user may not finish his or her job of viewing all the frames in a ten-minute video until almost 20,000 frames are viewed. As a result, when computer software is used for editing the video content, a first frame of the video content is often representative of the video. In some computer software, in order to facilitate the understanding of the user regarding the video and thus facilitate the processes of video editing, some frames of the video are often shown by way of a thumbnail sequence. However, there are a number of methods that are currently used for selecting some frames of the video. In one method, a plurality of first frames is selected based on different filming dates or discontinuous filming times. In another method, a frame is selected at a certain time interval. In still another method, first frames are selected by analyzing the video content based on different shot shifts. In yet still another method, the frames are selected manually.

When the video content is a photograph, music video, drama, film or television series, characters usually are the protagonists of the video content. Therefore, by utilizing the character thumbnail sequence representative of the video, it is possible to provide the users with a method for quickly viewing the frames of the characters in the photographs, music videos, dramas, films or television series, especially when the frames are meaningful and representative for the users. However, there is no method disclosed for generating a thumbnail sequence by selecting some frames from the video according to the characters of the video content. Therefore, it is an important matter to provide a method and system for a generating thumbnail sequence by automatically selecting meaningful and representative character frames from the video.

### SUMMARY OF THE INVENTION

In view of the above-mentioned problems, it is therefore an object of the invention to provide a system and method for generating a character thumbnail sequence, wherein the system and method are capable of efficiently analyzing the video and generating the required character thumbnail sequence.

To achieve the above-mentioned object, the system for generating a character thumbnail sequence according to the invention includes a video-receiving module, a decoding module, a video-extracting module and a character-thumbnail-sequence-generating module. In this invention, the video-receiving module receives video source data. The decoding module decodes the video source data into video data. Then, the video-extracting module extracts at least one key frame from the video data according to a character-image extraction guide. Finally, the character-thumbnail-sequence-generating module generates a character thumbnail sequence according to the extracted key frame.

As described above, the system for generating the character thumbnail sequence according to the invention further includes an image-processing module for image-processing the extracted key frame.

The system for generating the character thumbnail sequence according to the invention further includes an extraction-guide-selecting module for receiving a command from a user to select the character-image extraction guide.

The invention also provides a method for generating a character thumbnail sequence, which includes a video-receiving step, a decoding step, a video extraction step and a character thumbnail-sequence-generating step. In this invention, the video-receiving step is performed first to receive video source data.

Next, the decoding step is performed to decode the video source data to obtain video data. Then, the video extraction step is performed to extract a key frame according to a character-image extraction guide. Finally, the character thumbnail-sequence-generating step generates the character thumbnail sequence according to the key frame.

In addition, the method for generating the character thumbnail sequence according to the invention further includes an image-processing step for image-processing the extracted key frame.

The system and method for generating the character thumbnail sequence according to the invention can automatically analyze the video and extract the images satisfy the requirements. Therefore, the required character thumbnail sequence can be efficiently generated.

### BRIEF DESCRIPTION OF THE DRAWINGS

FIG. 1 is a schematic illustration showing the architecture of a system for generating a character thumbnail sequence in accordance with a preferred embodiment of the invention.

FIG. 2 is a flow chart showing a method for generating the character thumbnail sequence in accordance with the preferred embodiment of the invention.

FIG. 3 is a schematic illustration showing the processes for extracting key frames in the method for generating the character thumbnail sequence in accordance with the preferred embodiment of the invention.

FIG. 4 is a schematic illustration showing the data storage structure of a different-face image library in accordance with the preferred embodiment of the invention.

### DETAIL DESCRIPTION OF THE INVENTION

The system and method for generating the character thumbnail sequence in accordance with a preferred embodiment of the invention will be described with reference to the accompanying drawings, wherein the same reference numbers denote the same elements.

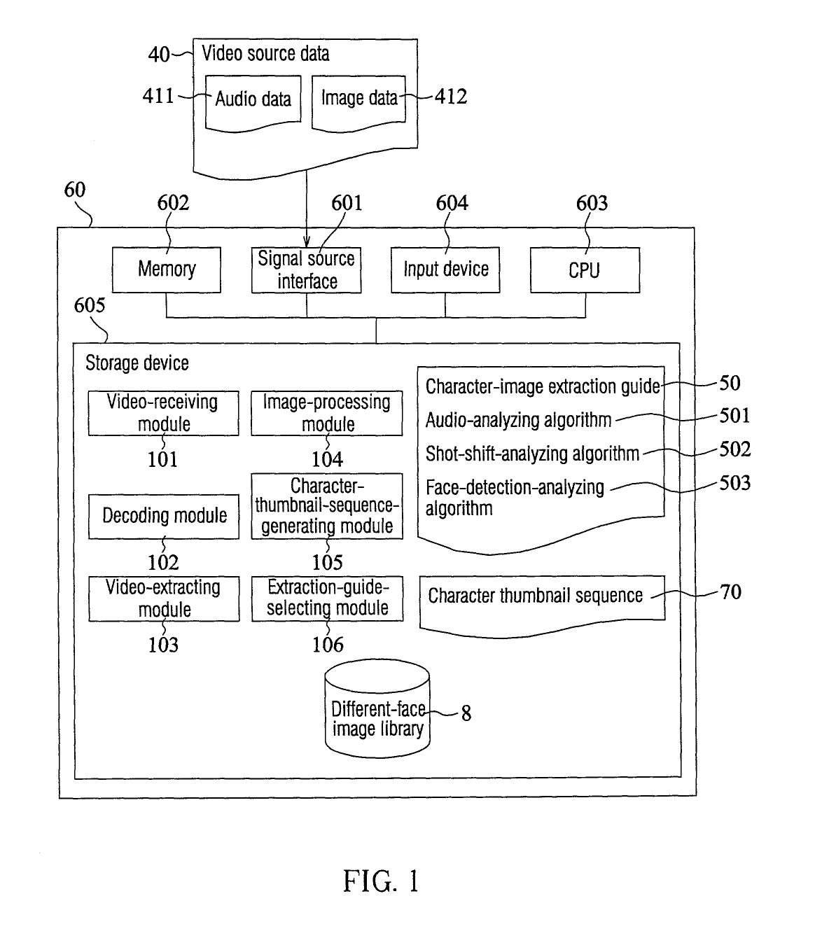

Referring to FIG. 1, a system for generating the character thumbnail sequence in accordance with a preferred embodiment of the invention includes a video-receiving module 101, a decoding module 102, a video-extracting module 103, an image-processing module 104, a character-thumbnail-sequence-generating module 105, and an extraction-guide-selecting module 106.

In this embodiment, the system for generating the character thumbnail sequence can be used with a computer apparatus 60. The computer apparatus 60 may be a conventional computer device including a signal source interface 601, a memory 602, a central processing unit (CPU) 603, an input device 604, and a storage device 605. The signal source interface 601 is connected to a signal-source output device or a signal-source-recording device. The signal source interface 601 can be any interface device such as an optical disk player, a FireWire (IEEE 1394 Interface), or a universal serial bus (USB). The signal-source output device is, for example, a digital video camera, while a signal-source-recording device is, for example, a VCD, DVD, and the like. The memory 602 may be any memory component or a number of memory components, such as DRAMs, SDRAMs or EEPROMs, provided in the computer device. The central processing unit 603 adopts any conventional central processing architecture including, for example, an ALU, a register, a controller, and the like. Thus, the CPU 603 is capable of processing and operating with all data, and controlling the operations of every element in the computer apparatus 60. The input device 604 may be a device that can be used by users to input information or interact with software modules, for example, a mouse, keyboard, and the like. The storage device 605 may be any data storage device or a number of data storage devices that can be accessed by using computers, for example, a hard disk, a floppy disk, and the like.

Each of the modules mentioned in this embodiment refers to a software module stored in the storage device 605 or a recording media. Each module is executed by the central processing unit 603, and the functions of each module are implemented by the elements in the computer apparatus 60. However, as is well known to those skilled in the art, it should be noted that each software module can also be manufactured into a piece of hardware, such as an ASIC (application-specific integrated circuit) chip and the like, without departing from the spirit or scope of the invention.

The functions of each module of the embodiment will be described in the following.

In this embodiment, the video-receiving module 101 receives video source data 40. The decoding module 102 decodes the video source data 40 to obtain video data 41. The extraction-guide-selecting module 106 provides an interface for a user to select a character-image extraction guide 50. The video-extracting module 103 extracts at least one key frame 302 from the video data 41 according to the character-image extraction guide 50. Then, the image-processing module 104 image-processes the key frame 302 extracted by the video-extracting module 103. Finally, the character-thumbnail-sequence-generating module 105 generates a character thumbnail sequence 70 according to the image of the key frame 302 that is image-processed.

As described above, the video-receiving module 101 operates in combination with the signal source interface 601. For example, the video source data 40 stored in a digital video camera are transferred to the video-receiving module 101 through the FireWire (IEEE 1394 Interface). Alternatively, the video source data 40 recorded in a VCD or DVD are transferred to the video-receiving module 101 through an optical disk player. The video source data 40 may be the video that is stored, transferred, broadcast, or received by various video-capturing or receiving devices such as digital cameras, TV tuner cards, setup boxes and the like, or by various video storage devices such as DVDs and VCDs. Also, the video source data 40 may be stored, transferred, broadcast, or received in various video data formats, such as MPEG-1, MPEG-2, MPEG-4, AVI, ASF, MOV, and the like.

The decoding module 102 decodes, converts, and decompresses the input video source data 40, according to its video format, encoded method, or compressed method, into the data the same as or similar to those before encoded. By doing so, the video data 41 can be generated. For example, if the video source data 40 has been encoded by the lossy compression, only the data similar to those before encoded can be obtained after the decoding process. In this embodiment, the video data 41 include audio data 411 and image data 412. The audio data 411 are the sounds in the video data 41. The image data 412 are all the individual frames shown in the video data 41. Usually, one second of the video data 41 is composed of 25 individual frames or 29.97 individual frames that are sequentially shown on the screen. In this embodiment, the position information of each frame with respect to the video data 41 is represented by “hour: minute: second: frame”. For example, “01: 11: 20: 25” represents the 25th frame at 20th second at 11th minute at 1st hour.

The extraction-guide-selecting module 106 operates in combination with the input device 604 so that the user can select the required character-image extraction guide 50 from the extraction-guide-selecting module 106 by way of the input device 604. According to the character-image extraction guide 50 provided in this embodiment and the preferences input by the user, it is decided whether or not to utilize an audio-analyzing algorithm 501 and a shot-shift-analyzing algorithm 502 as pre-processing procedures before a face-detection-analyzing algorithm 503 is made for processing the video data. The processing procedures of the audio-analyzing algorithm 501 and shot-shift-analyzing algorithm 502 will decrease the amount of the video data processed by the face-detection-analyzing algorithm 503.

The audio-analyzing algorithm 501 is used to analyze the audio data 411 of the video data 41 so that audio data fragments with human voice included in the audio data 411 and their corresponding image data fragment in the image data 412 are screened. Therefore, the audio data fragments of non-human sounds, such as noises or silence, and their corresponding image data fragments can be separated, and no process using the face-detection-analyzing algorithm is performed.

The audio-analyzing algorithm 501 is used to analyze sounds, by way of feature extraction and feature matching methods, to distinguish and classify the voices of the characters. The features of the audio data 411 include, for example, the frequency spectrum feature, the volume, the zero crossing rate, the pitch, and the like. As described above, after the audio features in time domain are extracted, the audio data 411 are passed to the noise reduction and segmentation processes. Then, the Fast Fourier Transform method is used to convert the audio data 411 to the frequency domain. Then, a set of frequency filters is used to extract the feature values, which constitute a frequency spectrum feature vector. The volume is a feature that is easily measured, and an RMS (Root Mean Square) can represent the feature value of the volume. Then, by volume analysis, the segmentation operation can be assisted. That is, using the silence detection, the segment boundaries of the audio data 411 can be determined. The zero crossing rate is used to calculate the number of times that each clip of sound waveform intersects a zero axis. The pitch is a fundamental frequency of the sound waveform. Therefore, in the audio data 411, the feature vector constituted by the above-mentioned audio features and the frequency spectrum feature vector thereof can be used to analyze and compare the features of the audio templates having human voices, so that the audio data fragments with human voices and corresponding image data fragments can be obtained.

The shot-shift-analyzing algorithm 502 is used to analyze the shot shifts of the image data 412 in the video data 41, and to screen the first frames after every shot shift of the image data 412 in the video data 41. The first frames are regarded as the image data for the face-detection-analyzing algorithm 503. The image data 412 analyzed in the shot-shift-analyzing algorithm 502 may be the image data 412 corresponding to the audio data with human voices after the screening process in the audio-analyzing algorithm 501, or the image data 412 in the video data 41 that are not processed by the audio-analyzing algorithm 501.

In general, the video data 41 are video sequences composed of a number of scenes. Each scene is composed of a plurality of shots. The minimum unit in the film is a shot. The film is composed of a number of shots. Usually, a shot is composed of a plurality of frames having uniform visual properties, such as color, texture, shape, and motion. The shots shift with the changes in camera direction and the angle of view. For instance, different shots are generated when the camera shoots the same scene with different angles of view. Alternatively, different shots are generated when the camera shoots different regions with the same angle of view. Since the shots can be distinguished according to some basic visual properties, it is very simple to divide the video data 41 into a plurality of sequential shots by using a technology in which statistical data, such as the visual property histogram, of some basic visual properties are analyzed. Therefore, when the visual properties of one frame are different from the visual properties of a previous frame to a certain extent, a split can be made between the one frame and the previous frame to produce a shot shift. In this embodiment, a first frame after the shot shift can be selected and used as the image data for the face-detection-analyzing algorithm 503.

The face-detection-analyzing algorithm 503 is used to search the video data 41 for video frames having different face features, to be used as key frames 302 by face detection and face recognition technologies. The image data 412 analyzed in the face-detection-analyzing algorithm 503 may be the image data 412 after the screening process in the audio-analyzing algorithm 501 or shot-shift-analyzing algorithm 502, or the image data 412 that are not screened in the audio-analyzing algorithm 501 or shot-shift-analyzing algorithm 502.

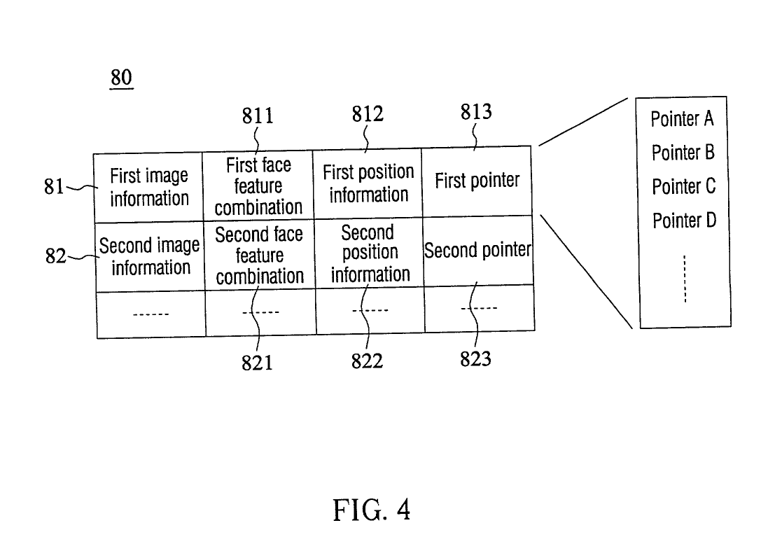

In this embodiment, a different-face image library 8 is used. In the different-face image library 8, a data table 80 is used to store the image information of different faces, the face feature combinations of the different-face images, and the position information of the images. Furthermore, a data linked list is used to store the position information of the images having the same facial features as those of the different faces. In FIG. 4, the data stored in the different-face image library 8 are shown. For example, in a first row of the data table 80 are stored a first image information 81 of a first face, a first face feature combination 811 representative of the first face, a first position information 812 of the first image, and a plurality of first pointers (such as pointers A, B, C, D . . . ) 813 linked to other images having the first face. According to same manner, in a second row of the data table 8 are stored a second image information 82 of a second face, a second face feature combination 821 representative of the second face, a second position information 822 of the second image, and a plurality of second pointers 823 linked to other images having the second face.

In this embodiment, images having face frames are first screened from the inputted image data 412 by the face detection technology. Then, the facial features in the images having face frames are detected. Next, a first image having a face frame or frames, a face feature combination of the first image, and the position information of the first image are stored into the “different-face image library.” When other image having face frames is reviewed, the face feature combination of the image is compared with the face feature combination saved in the “different-face image library.” If the face feature combination of the image is the same as that stored in the “different-face image library,” the image is discarded, and the position information of the discarded image are stored in the data linked list corresponding to the image having the same feature combination in the “different-face image library.” If the face feature combination of the image is different from that stored in the “different-face image library,” the image, its face feature combination, and its position information is stored into the “different-face image library.” In this way, the face recognition and comparison processes of the inputted image data 412 are finished sequentially. Finally, the images stored in the “different-face image library” are the key frames 302 that are screened in this embodiment. The face recognition method that is often used at present is the PCA (Principal Component Analysis) method. The face recognition device constructed by this method is usually designated as an eigenface recognition system.

The video-extracting module 103 may be a software module stored in the storage device 605. By a combination of operations, the central processing unit 603 analyzes the frames in the video data 41 and they are compared using the character-image extraction guide 50 provided in this embodiment. Thus, the key frames 302 that agree with the character-image extraction guide 50 are extracted.

The image-processing module 104 may be a software module stored in the storage device 605. By the operation of the central processing unit 603, the extracted key frames 302 are image-processed using image-processing functions such as resealing, and the like.

The character-thumbnail-sequence-generating module 105 may be a software module stored in the storage device 605. By the operation of the central processing unit 603, the image-processed key frames 302 are integrated and exported to generate the character thumbnail sequence 70.

In addition, the generated character thumbnail sequence 70 may be stored in the storage device 605. The stored data may include a header of the character thumbnail sequence 70, linked lists or pointers of each of the key frames 302 (or thumbnails), and the like.

For the sake of ease of understanding the content of the invention, a method is disclosed to illustrate the procedures for generating the character thumbnail sequence in accordance with the preferred embodiment of the invention.

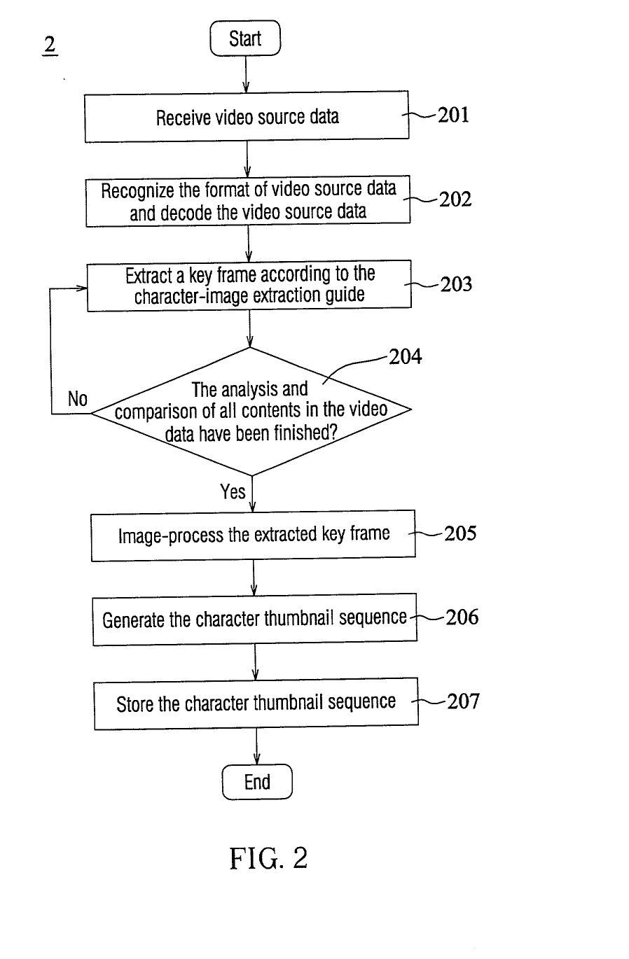

As shown in FIG. 2, in the character-thumbnail-sequence-generating method 2 according to the preferred embodiment of the invention, the video source data 40 are received in step 201. For example, the video source data 40 recorded in the digital video camera can be transferred to the signal source interface 601 through a transmission cable, so that the video source data 40 can be used as the frames and content for generating the character thumbnail sequence 70.

In step 202, the decoding module 102 recognizes the format of the video source data 40 and decodes the video source data 40 to generate the decoded video data 41. For example, the format of the video source data 40 is an Interlaced MPEG-2 format. That is, it is a frame composed of two fields. Thus, in this step, the MPEG-2 format can be decoded first, and then, the video data 41 can be obtained by deinterlacing with interpolation and can be displayed by a computer monitor.

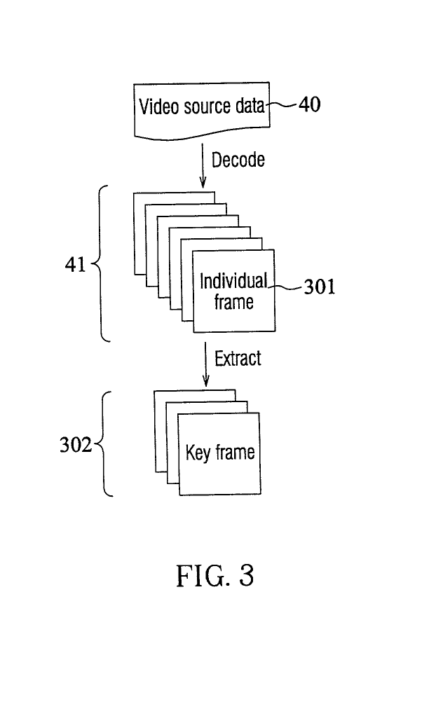

In step 203, the video-extracting module 103 executes the selected character-image extraction guide 50 in the extraction-guide-selecting module 106 for extracting key frames 302 according to the preference information input through input device 604 by the user. That is, before the video data are processed by the face-detection-analyzing algorithm 503 of the character, the user decides whether or not to use the audio-analyzing algorithm 501 and the shot-shift-analyzing algorithm 502 as pre-processing procedures. Every video frame and all of the content (including the audio content) of the video data 41 are analyzed, searched, and screened, to obtain the key frames 302 that agree with the character-image extraction guide 50. It should be noted that a plurality of key frames 302 could be extracted in this embodiment. As shown in FIG. 3, the video data 41 including a plurality of individual frames 301 (25 or 29.97 frames per second) are obtained after the video source data 40 are decoded. At least one key frame 302 is extracted from the individual frames 301 after the analysis and search are performed according to the character-image extraction guide 50.

Step 204 judges that whether or not all the content in the video data 41 have been analyzed and compared. If all the content in the video data 41 have not been analyzed and compared, step 203 is repeated. If all the content in the video data 41 have been analyzed and compared, step 205 is then performed.

In step 205, the image-processing module 104 processes the resolutions and sizes of the thumbnail frames according to the key frames 302 obtained in step 203. For example, the image-processing module 104 may perform a rescaling process.

In step 206, the character-thumbnail-sequence-generating module 105 integrates the image-processed key frames 302 to generate the character thumbnail sequence 70. For example, after the extracted key frames 302 are rescaled, the key frames 302 are arranged in order in a window by the character-thumbnail-sequence-generating module 105. Furthermore, when the number of the frames exceeds a predetermined number of frames that can be shown in one window, a scroll bar is used to provide the user a better way of browsing the character thumbnail sequence 70.

Also, the key frames 302 may be the first image information 81, the second image information 82, and the like, as shown in FIG. 4. Thus, all images of different faces in the video data 41 are shown in the generated character thumbnail sequence 70, wherein the images of different faces may be representative of the thumbnail sequence of all appearing characters in the video data 41. In addition, the key frames 302 may be the first image information 81 and other images with the first face as shown in FIG. 4. Therefore, all images with the first face in the video data 41 are shown in the generated character thumbnail sequence 70, wherein the images with the first face may be representative of the thumbnail sequence of the characters having the first face in the video data 41. In addition, the key frames 302 with the image of the first face further can be integrated into the album video data of a specific character, which can be regarded as a personal album of a specific character with the first face.

Finally, in step 207, the storage device 605 stores the character thumbnail sequence 70 with the data structure, such as linked lists, defined by the programs. The headers of the linked lists include filename information of the character thumbnail sequence 70, or other similar information. Each node includes the information of a character thumbnail (character thumbnail image data or the pointer of character thumbnail image) and information regarding the links between the current node and a previous (or next) node.

To sum up, the system and method for generating the character thumbnail sequence in accordance with the preferred embodiment of the invention are capable of automatically analyzing the video data. Furthermore, for the audio data and image data of the video data, the system and method can integrate the technologies of video content analysis, audio analysis, face detection, face recognition, and the like, so as to generate the character thumbnail sequence. Therefore, the required character thumbnail sequence can be generated from the video data efficiently.

In addition, the case when a user uses the system and method for generating the character thumbnail sequence in accordance with the embodiment of the invention is discussed hereinbelow. If the user does not select the audio-analyzing algorithm 501 and the shot-shift-analyzing algorithm 502 from the preferences for generating the character thumbnail sequence for screening, the user can select the thumbnails in the character thumbnail sequence. Furthermore, according to the images of the thumbnails corresponding to different faces in the “different-face image library” and corresponding to data linked lists, in which position information of the images with the same face features as those in the character thumbnail image are stored, the user can obtain the images with the same face features in the video. Then, the user can perform the processes for batch video-editing or image-editing, deleting or replacing all the images with the same face features, image enhancement for adding video effects, brightness, and color adjustment, or the like.

If the user does select the audio-analyzing algorithm 501 or the shot-shift-analyzing algorithm 502 from the preferences for generating the character thumbnail sequence for screening, the user can select the thumbnails in the character thumbnail sequence. Furthermore, according to the images of the thumbnails corresponding to different faces in the “different-face image library” and to the data linked lists, the user can obtain the images with the same face features in the video after the images have been screened by the audio-analyzing algorithm 501 or the shot-shift-analyzing algorithm 502. Then, the user can perform the processes for batch video-editing or image-editing, deleting or replacing all the images with the same face features, image enhancement, adding video effects, adjusting brightness and color, or the like.

For example, all the images with the same face features can be merged, in a batch manner, into a personal video album of the specific character. Furthermore, the user can manually perform video-editing or image-editing processes on the selected personal video album through the image-processing module 104. The video-editing or image-editing processes can be the processes of, for example, deleting or replacing all the images with the same face features, image enhancement, adding video effects, adjusting brightness and color of the images, or the like.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A system for generating a character thumbnail sequence, comprising:
a video-receiving module for receiving video source data;
a decoding module for decoding the video source data to obtain video data;
a video-extracting module for extracting a key frame from the video data according to a character-image extraction guide; and
a character-thumbnail-sequence-generating module for generating a character thumbnail sequence according to the extracted key frame.

2. The system according to claim 1, further comprising:
an image-processing module for image-processing the extracted key frame after the key frame is extracted.

3. The system according to claim 1, further comprising:
an extraction-guide-selecting module for receiving a command from a user to select the character-image extraction guide.

4. The system according to claim 1, wherein the character-image extraction guide comprises a face-detection-analyzing algorithm by which image data with face features in the video data are analyzed, the video-extracting module extracts the key frame from the image data according to the face-detection-analyzing algorithm.

5. The system according to claim 4, wherein the video-extracting module extracts the image data with the same face features as the key frame according to the face-detection-analyzing algorithm.

6. The system according to claim 5, wherein the character thumbnail sequence is a thumbnail sequence of a specific character.

7. The system according to claim 6, further generating album video data of the specific character according to the thumbnail sequence of the specific character.

8. The system according to claim 4, wherein the video-extracting module extracts the image data with different face features as the key frame according to the face-detection-analyzing algorithm.

9. The system according to claim 4, wherein the character-image extraction guide further comprises an audio-analyzing algorithm by which audio data in the video data are analyzed, the video-extracting module screens the image data corresponding to the audio data with human voices according to the audio-analyzing algorithm, and then extracts the key frame from the image data according to the face-detection-analyzing algorithm.

10. The system according to claim 4, wherein the character-image extraction guide further comprises a shot-shift-analyzing algorithm by which shot shifts of the image data in the video data are analyzed, the video-extracting module screens the image data according to the shot-shift-analyzing algorithm, and then extracts the key frame from the image data according to the face-detection-analyzing algorithm.

11. A method for generating a character thumbnail sequence, comprising:
a video-receiving step for receiving video data;
a decoding step for decoding the video source data to obtain video data;
a video extraction step for extracting a key frame from the video data according to a character-image extraction guide; and
a thumbnail-sequence-generating step for generating a thumbnail sequence according to the extracted key frame.

12. The method according to claim 11, further comprising:
an image-processing step for image-processing the extracted key frame.

13. The method according to claim 11, further comprising:
an extraction-guide-selecting step for receiving a command from a user to select the character-image extraction guide.

14. The method according to claim 11, wherein the character-image extraction guide comprises a face-detection-analyzing algorithm by which image data with face features in the video data are analyzed, the video extraction step is performed for extracting the key frame from the image data according to the face-detection-analyzing algorithm.

15. The method according to claim 14, wherein the video-extracting step is performed for extracting the image data with the same face features as the key frame according to the face-detection-analyzing algorithm.

16. The method according to claim 15, wherein the character thumbnail sequence is a thumbnail sequence of a specific character.

17. The method according to claim 16, further generating album video data of the specific character according to the thumbnail sequence of the specific character.

18. The method according to claim 14, wherein the video-extracting step is performed for extracting the image data with different face features as the key frame according to the face-detection-analyzing algorithm.

19. The method according to claim 14, wherein the character-image extraction guide further comprises an audio-analyzing algorithm by which audio data in the video data are analyzed, the video-extracting module screens the image data corresponding to the audio data with human voices according to the audio-analyzing algorithm, and then extracts the key frame from the image data according to the face-detection-analyzing algorithm.

20. The method according to claim 14, wherein the character-image extraction guide further comprises a shot-shift-analyzing algorithm by which shot shifts of the image data in the video data are analyzed, the video-extracting step is performed for screening the image data according to the shot-shift-analyzing algorithm, and then to extract the key frame from the image data according to the face-detection-analyzing algorithm.

21. A recording medium on which is recorded a program to enable a computer to perform a method for generating a character thumbnail sequence, the method for generating the character thumbnail sequence comprising:
a video-receiving step for receiving video data;
a decoding step for decoding the video source data to obtain video data;
a video extraction step for extracting a key frame from the video data according to a character-image extraction guide; and
a character-thumbnail-sequence-generating step for generating a character thumbnail sequence according to the extracted key frame.

22. The recording medium according to claim 21, wherein the method further comprises:
an image-processing step for image-processing the extracted key frame.

23. The recording medium according to claim 21, wherein the method further comprises:
an extraction-guide-selecting step for receiving a command from a user to select the character-image extraction guide.

24. The recording medium according to claim 21, wherein the character-image extraction guide comprises a face-detection-analyzing algorithm by which image data with face features in the video data are analyzed, the video extraction step is performed for extracting the key frame from the image data according to the face-detection-analyzing algorithm.

25. The recording medium according to claim 24, wherein the video-extracting step is performed for extracting the image data with the same face features as the key frame according to the face-detection-analyzing algorithm.

26. The recording medium according to claim 25, wherein the character thumbnail sequence is a thumbnail sequence of a specific character.

27. The recording medium according to claim 26, wherein the method further generating album video data of the specific character according to the thumbnail sequence of the specific character.

28. The recording medium according to claim 24, wherein the video-extracting step is performed for extracting the image data with different face features as the key frame according to the face-detection-analyzing algorithm.

29. The recording medium according to claim 24, wherein the character-image extraction guide further comprises an audio-analyzing algorithm by which audio data in the video data are analyzed, the video-extracting module screens the image data corresponding to the audio data with human voices according to the audio-analyzing algorithm, and then extracts the key frame from the image data according to the face-detection-analyzing algorithm.

30. The recording medium according to claim 24, wherein the character-image extraction guide further comprises a shot-shift-analyzing algorithm by which shot shifts of the image data in the video data are analyzed, the video-extracting step is performed for screening the image data according to the shot-shift-analyzing algorithm, and then for extracting the key frame from the image data according to the face-detection-analyzing algorithm.
